(19) United States
(12) Patent Application Publication
(10) Pub. No.: US 2006/0151471 A1
(43) Pub. Date: Jul. 13, 2006

(54) Cooking apparatus

(75) Inventors: Seong-deog Jang, Suwon-si (KR); Han-seong Kang, Suwon-si (KR); Yong-hyun Kwon, Suwon-si (KR); Chul Kim, Yongin-si (KR); Han-Jun Sung, Suwon-si (KR); Dae-sung Han, Hwaseong-si (KR); Tae-uk Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (JP)

(21) Appl. No.: 11/298,832

(22) Filed: Dec. 12, 2005

(30) Foreign Application Priority Data
Jan. 13, 2005 (KR) 10-2005-0003311

(51) Int. Cl. H05B 3/68

(52) U.S. Cl. 219/450.1

(57) ABSTRACT

A cooking apparatus having a cooking apparatus having a grill part to cook food thereon, and an electric heater provided in a lower side of the grill part. The cooking apparatus includes a grill reflecting member provided in a lower side of the electric heater to reflect heat generated from the electric heater to the grill part, and a cooling fan disposed at a lower side of the grill reflecting member to ventilate an outside air to the grill reflecting member. Thus, the present invention provides a cooking apparatus enhancing a cooling efficiency of a grill housing and a grill reflecting member.

### CROSS-REFERENCE TO RELATED APPLICATIONS

This application claims the benefit of Korean Patent Application No. 10-2005-0003311, filed on Jan. 13, 2005, in the Korean Intellectual Property Office, the disclosure of which is incorporated herein by reference.

### BACKGROUND OF THE INVENTION

1. Field of the Invention

The present invention relates to a cooking apparatus. More particularly, to a cooking apparatus enhancing a cooling efficiency of a grill housing and a grill reflecting member.

2. Description of the Related Art

Conventionally, “grilling” refers to a method of broiling meats. on a gridiron or directly roasting skewered meats or fishes on the fire. A grill device is a kind of household electric appliance to broil them by using electricity or gas.

Particularly, an electric grill device cooks food by using an electric heater as a heating source to generate the heat by the electric power. A main body of the electric grill device comprises a grill part directly contacting and cooking food. Heat from the electric heater is reflected to the grill part by a grill reflecting member and used when food is cooked. At this time, if the temperature of the grill reflecting member rises excessively, fumes are generated while oil or residues coming out of food adhered on the grill reflecting member is burning.

In the cooking apparatus cooking food by using heat, a cooling fan is used so as to prevent the temperature of cooking apparatus from rising excessively.

A cooling configuration of an electric cooking apparatus disclosed in Korean Utility Model Second Publication No. 1989-0001583 includes a guiding rib having ventilation holes in three directions in a mounting part of a cooling fan, for covering a motor bracket to form a casing, an air guiding blade connected with each ventilation hole forming an air transferring path, and an air interrupting wall provided in a side plate of a heat sink.

However, the conventional cooling configuration has a problem in that the cooling efficiency decreases because cool air cannot directly cool a part which needs cooling.

### SUMMARY OF THE INVENTION

Accordingly, it is an aspect of the present invention to provide a cooking apparatus enhancing a cooling efficiency of a grill housing and a grill reflecting member.

Additional aspects and/or advantages of the invention will be set forth in part in the description which follows and, in part, will be apparent from the description, or may be learned by practice of the invention.

The foregoing and/or other aspects of the present invention are achieved by providing a cooking apparatus having a grill part to cook food thereon, and an electric heater provided in a lower side of the grill part, the cooking apparatus including a grill reflecting member provided in a lower side of the electric heater, to reflect heat generated from the electric heater to the grill part, and a cooling fan disposed at a lower side of the grill reflecting member, to ventilate an outside air to the grill reflecting member.

The cooking apparatus further includes a grill housing coupled with a lower part of the grill part, to accommodate the electric heater and the grill reflecting member, wherein the cooling fan is provided in a lower area of the grill housing to be disposed at the lower side of the grill reflecting member.

The grill housing includes an inner casing and an outer casing disposed such that a space is formed therebetween, the grill housing including a fan mounting hole in which the cooling fan is mounted, passing through the inner casing and the outer casing.

The inner casing includes a through hole passing the air guided toward the grill reflecting member to the space between the inner casing and the outer casing.

The outer casing includes an outlet discharging the air flowed in the space between the inner casing and the outer casing.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is an exploded perspective view illustrating a cooking apparatus according to the present invention; and

FIG. 2 is an assembled sectional view of FIG. 1.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

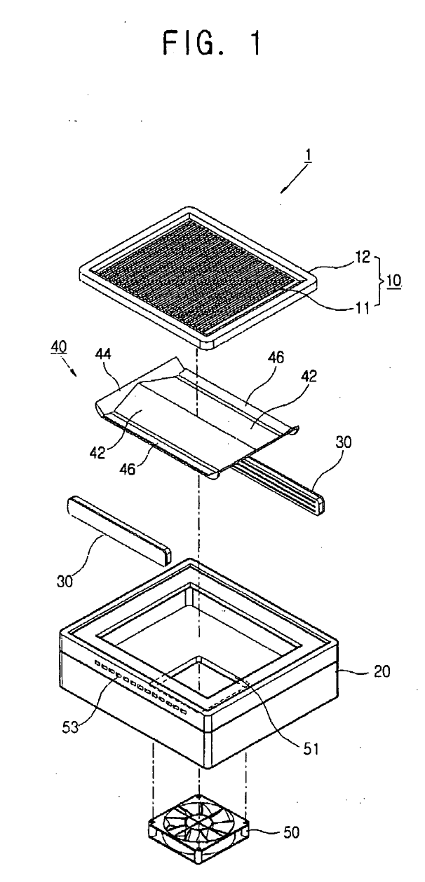

In FIG. 1, a cooking apparatus 1 according to an embodiment of the present invention comprises a grill part 10 on which food is cooked, and a grill housing 20 coupled with a lower part of the grill part 10, receiving a variety of parts and accessories therein.

The grill part 10 which directly contacts and cooks food, is coupled with an upper part of the grill housing 20. The grill part 10 comprises a plurality of grill bars 11 disposed at predetermined intervals so as to make food safely seated thereon, and a support frame 12 supporting the plurality of grill bars 11 along the circumferential direction thereof.

The grill housing 20 supports the lower part of the grill part 10 mounted on an upper opening part thereof, inside of which a heating space is formed. Inside the grill housing 20 are received electric heaters 30 formed in a pair as heating source, and a grill reflecting member 40 reflecting heat from the electric heaters 30.

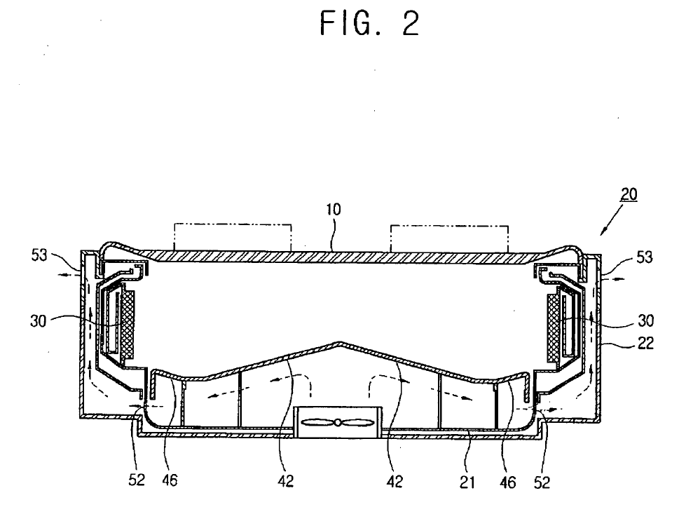

In FIG. 2, the grill housing 20 comprises an inner casing 21 forming the heating space inside of the grill housing 20 and a outer casing 22 disposed such that a space is formed between the inner casing 21 and the outer casing 22. In a lower area of the grill housing 20 is formed a fan mounting hole 51 passing through the inner casing 21 and the outer casing 22. In the fan mounting hole 51 is mounted a cooling fan 50 for cooling the grill housing 20 and the grill reflecting member 40.

The inner casing 21 comprises through holes 52 passing air in flowed from an outside to the space between the inner casing 21 and the outer casing 22 by the cooling fan 50.

The outer casing 22 comprises outlets 53 discharging the air circulating the space therebetween.

The electric heaters 30 are installed opposite each other on both side walls inside the grill housing 20 so that they are disposed in a lower side of the grill part 10. Heat generated in the electric heaters 30 is transmitted to the grill part 10 by the grill reflecting member 40.

The grill reflecting member 40 comprises an approximately W-shaped section. The grill reflecting member 40 is made of metallic materials having a good thermal conductivity so as to reflect the heat generated from the electric heaters 30 and then transmit it to the grill part 10.

The grill reflecting member 40 comprises a pair of first reflection faces 42 interconnected in a center thereof, auxiliary reflection faces 46 formed opposite to the first reflection faces 42, and a second reflection face 44 extended from ends of the first reflection faces 42 and the auxiliary reflection faces 46.

The first reflection faces 42 are disposed in the direction of emitting the heat from the electric heaters 30. That is, in front of the electric heaters 30, to thereby reflect the heat generated from the electric heaters 30 to the grill part 10 in a bent manner. The auxiliary reflection faces 46 are adjacent to the electric heaters 30, for which their temperatures become high while the cooking apparatus 1 is in operation.

The second reflection face 44 is disposed laterally to the heat emitting direction of the electric heaters 30. The second reflection face 44 is smoothly curved so as to allow the heat generated from the electric heaters 30 to be reflected to the grill part 10 in a bent manner.

Hereinbelow, in the cooking apparatus with this configuration, a process of cooling the grill reflecting member 40 and the inside of the grill housing 20 will be described.

In FIG. 2, in the case of the electric heaters 30 disposed in the lower side of the grill part 10, the grill reflecting member 40 disposed in a lower side of the electric heaters 30, and the cooling fan 50 disposed in a lower side of the grill reflecting member 40, when the electric heaters 30 generate heat, food is cooked in the grill part 10. The grill reflecting member 40 and the inside of the grill housing 20 are heated by the generation of heat from the electric heaters 30 and they are cooled by the cooling fan 50.

When the cooling fan 50 operates, the outside air is ventilated to the lower side of the grill reflecting member 40, thereby cooling the grill reflecting member 40. The air is flowed to the space therebetween via the through holes 52 formed in the inner casing 21, thereby cooling the grill housing 20. Then, the air is discharged via the outlets 53 formed in the outer casing 22.

This is, in the cooking apparatus according to an embodiment of the present invention, the cooling fan 50 is provided in the lower side of the grill housing 20, so that the outside air is flowed to the lower side of the grill reflecting member 40 to be cooling the grill reflecting member 40. Then, the air is flowed between the inner casing 21 and the outer casing 22 to be cooing the grill housing 20, so that the grill reflecting member 40 and the grill housing 20 can be cooled together. Therefore, the cooling efficiency of the cooking apparatus can be improved.

As described above, the present invention provides a cooking apparatus enhancing a cooling efficiency of a grill housing and a grill reflecting member.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A cooking apparatus having a grill part to cook food thereon, and an electric heater provided in a lower side of the grill part, the cooking apparatus comprising:
a grill reflecting member provided in a lower side of the electric heater to reflect heat generated from the electric heater to the grill part; and
a cooling fan disposed at a lower side of the grill reflecting member to ventilate an outside air to the grill reflecting member.

2. The cooking apparatus according to claim 1, further comprising a grill housing coupled with a lower part of the grill part to accommodate the electric heater and the grill reflecting member,
wherein the cooling fan is provided in a lower area of the grill housing to be disposed at the lower side of the grill reflecting member.

3. The cooking apparatus according to claim 2, wherein the grill housing comprises an inner casing and an outer casing disposed such that a space is formed therebetween,
the grill housing comprises a fan mounting hole in which the cooling fan is mounted, passing through the inner casing and the outer casing, wherein the cooling fan cools the grill housing and the grill reflecting member.

4. The cooking apparatus according to claim 3, wherein the inner casing comprises a through hole passing the air guided toward the grill reflecting member to the space between the inner casing and the outer casing.

5. The cooking apparatus according to claim 4, wherein the outer casing comprises an outlet discharging the air flowed in the space between the inner casing and the outer casing.

6. The cooking apparatus according to claim 1, wherein the grill reflecting member comprises:
a pair of first reflection faces interconnected in a center thereof and disposed in a heat emitting direction of the electric heater, to reflect the heat generated from the electric heater onto the grill part in a bent manner;
a second reflection face disposed laterally to the heat emitting direction of the electric heater, to reflect heat generated from the electric heater in a bent manner.

7. The cooking apparatus of claim 6, wherein the grill reflecting member forms a W-shaped section.

8. A cooking apparatus having a grill part to cook food thereon and grill housing positioned underneath the grill part, the cooking apparatus comprising:
a plurality of heaters positioned in the grill housing opposite to each other to generate heat thereby cooking the food on the grill part;
a grill reflecting member positioned adjacent to the heaters, to reflect the heat generated by the heaters to the grill part; and
a cooling fan positioned underneath the grill reflecting member at a center of a lower part of the grill housing, to supply cool air to the grill housing and the grill reflecting member.

9. The cooking apparatus according to claim 8, wherein the grill housing comprising an inner casing and an outer casing forming a space therebetween, to allow the cool air supplied by the cooling fan to circulate therethrough.

10. The cooking apparatus according to claim 9, wherein
the inner casing comprises through holes and the grill reflecting member, to discharge the cool air circulating underneath the grill reflection member to the space between the inner casing and the outer casing; and
the outer casing comprises outlet holes to discharge the cool air from the outer casing to an outside of the grill housing.

11. The cooking apparatus according to claim 8, wherein the grill reflecting member comprises:
first reflection faces having inclined portions interconnected with each other at a center of the grill reflecting member, to reflect the heat generated by the heaters to the grill part; and
a second reflection face positioned in a direction perpendicular to a direction of the first reflection faces to reflect the heat generated by the heaters.

12. The cooking apparatus according to claim 11, wherein the grill reflecting member further comprises winged portions each connected with an outer edge of one of the first reflection faces, to reflect the heat generated by the heaters to the grill part.
